(19) United States
(12) Patent Application Publication
(10) Pub. No.: US 2003/0048918 A1
(43) Pub. Date: Mar. 13, 2003

(54) Installing a high fidelity sound, voice paging, or music system by mounting an electrical to acoustic transducer inside a wall mounted gang box

(76) Inventors: Geoffrey M. Dillon, Los Angeles, CA (US); Paul Sauer, Los Angeles, CA (US); Donald J. North, Los Angles, CA (US); Dai Z. Lee, Los Angeles, CA (US); Robert L. Goodman, Laguna Niquel, CA (US); David Liu, Arcadia, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/949,282

(22) Filed: Sep. 7, 2001

(51) Int. Cl. H04R 1/02; G08B 21/00

(52) U.S. Cl. 381/395; 181/150; 248/231.9; 381/386; 381/87; 361/600

(57) ABSTRACT

An acoustic transducer is secured to a plate having a front side and a back side. The transducer has an outer body with a front portion and rear portion and is sized to entirely fit inside an electrical gang box. A front-to-back enlarged opening in the plate is sized to receive the front portion of the transducer body. The transducer is secured to the plate so that the front portion is located within the front-to-back opening of the plate and is generally flush with the front side of the plate and most of the transducer body including the rear portion extends behind the plate into the gang box.

### BACKGROUND

This invention is in general related to the installation of electrical to acoustic transducers, such as loudspeakers, for high fidelity (i.e., hi-fi) sound, voice paging, or music systems, and more particularly to wall-mounted transducers in such systems.

Ceiling-mounted acoustic transducers used in conventional voice paging and background music systems are a useful space-saving feature. The transducers may be mounted at the time the residential or commercial building is actually being built or renovated for a new tenant. The location of the transducer is selected on a ceiling board to be installed, and a frame specifically designed for the transducer to attach to is installed at the location, when the ceiling board is installed. Sound or voice carrying wires for the transducer are routed from the frame along the ceiling, and then down through a wall, to a wall-mounted electrical connector to which the transmitter of a paging system is connected.

### BRIEF DESCRIPTION OF THE DRAWINGS

The invention is illustrated by way of example and not by way of limitation in the figures of the accompanying drawings in which like references indicate similar elements. It should be noted that references to “an” embodiment in this disclosure are not necessarily to the same embodiment, and they mean at least one.

FIG. 1 shows a hi-fi sound system that has been built using an embodiment of a method for installing a wall-mounted transducer.

FIG. 2 depicts a close-up side view of an embodiment of the embodiment of the wall-mounted transducer.

FIG. 3 illustrates a rear view of the wall-mounted transducer of FIG. 2, when taken apart.

FIG. 4 shows another embodiment of the wall-mounted transducer.

FIG. 5 depicts yet another embodiment of the wall-mounted transducer.

### DETAILED DESCRIPTION

An easier method for installing a hi-fi sound, voice paging, or background music system is described wherein the acoustic transducer is mounted to a wall using construction industry standard, wall mounted, gang boxes. According to an embodiment, the transducer is small enough to fit inside a conventional single-gang or multi-gang electrical gang box (sometimes called a ‘junction box’), so that a front portion of the transducer body is located within a front-to-back opening of a cover plate and is generally flush with the front side of the plate. Standard construction industry practice for routing electrical power wires through walls may also be used to route dedicated transducer wires to carry the music or voice signals to the transducer. Thus, the system may be built more efficiently (due to the use of a standard wall mounted gang box for which wire routing may be easily established) while maintaining the space-saving features of the ceiling mounted loudspeaker.

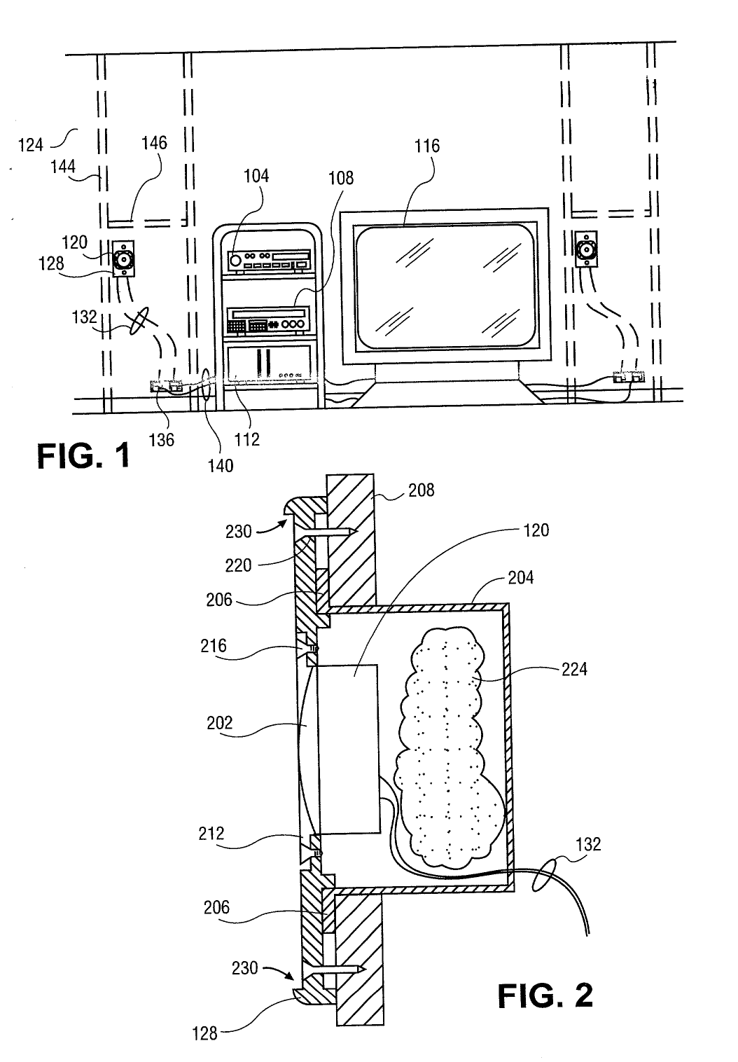

FIG. 1 shows a hi-fi sound system that has been built using a method that features employing an embodiment of the wall-mounted transducer. The hi-fi sound system has a number of decks, including, for example a radio frequency (i.e., RF) receiver deck 104, a compact disc and/or digital video disc player deck 108, and an amplifier deck 112. A wide range of other alternative music or voice broadcast system configurations may be used, including, for instance, a multi-speaker home entertainment audio and video system that has a screen display 116. In general, these systems use multiple transducers to accurately broadcast music or voice in a commercial or residential building. One such transducer 120 is shown in FIGS. 1-3 as being mounted inside a single-gang gang box that has been mounted inside a wall 124 at an industry standard height corresponding to the location of, for example, a toggle switch. Note the presence of conventional vertical studs 144 and horizontal studs 146 (also known as ‘fire breakers’) inside the wall 124. These studs may be made of wood or metal.

Referring briefly to FIG. 2, the transducer 120 includes a transducer body with a front portion and a rear portion. A diaphragm 202, which vibrates to generate sound waves, is in the front portion, while a coil (not shown), which moves the diaphragm, is housed in the rear portion. An embodiment of the transducer 120 is described in U.S. patent application Ser. No. 09/706,145, entitled “A Speaker For Use In Confined Spaces”, filed on Nov. 3, 2000, (status: pending), which has been assigned to the same assignee as that of the present application and is incorporated by reference herein. Alternatively, any electrical to acoustic transducer that has an audible frequency response that covers, for example, the entire range of approximately 100 Hz-20 KHz for accurate voice or music reproduction (be it foreground music or the typically much lower volume background music heard in, for example, elevators and hallways of a commercial building) and that completely fits inside a standard gang box as described below can be used. It should be noted that with current technologies, the efficiency of a relatively powerful acoustic transducer that is small enough to fit inside the single-gang gang box (such as the one shown in FIGS. 1-3) and that can be mass produced, may become too low below 100 Hz to be of any practical use.

Returning to FIG. 1, the transducer 120 is secured to a plate 128 whose front side is visible in FIG. 1. The plate 128 may be generally rectangular as shown, to cover a conventional rectangular gang box. However, other shapes that cover the contour of a gang box which is not rectangular may alternatively be used. The outer dimensions of the plate 128 may the same as those of industry standard components known as ‘device covers’. The plate 128 may be made of injection-molded plastic, for example, and has a front-to-back enlarged opening which, in the embodiment of FIG. 1, is generally circular and located at substantially the center of the plate 128. The enlarged opening is sized to receive the front portion of a body of the transducer 120. A non-circular opening may alternatively be provided, to receive the front portion of a transducer body which is not circular.

The installation of the hi-fi sound system also involves, in the embodiment shown in FIG. 1, routing a pair of transducer wires 132 through the wall 124 in which the gang box is mounted. The wires 132 are routed between a cut-out (not shown in FIG. 1) in a side or rear wall of the gang box, and a wall mounted electrical connector 136. They may be routed through plastic or metal wire conduits (not shown) that have been placed in the wall 124 during construction. The wires 132 are designed for conducting voice or music signals that can directly drive a coil of the transducer 120. The wall mounted connector 136 may be, for example, of the type in which its front end (exposed in FIG. 1) accepts a stripped end of a wire which is grasped between two metal tabs that are spring-loaded against each other. Other types of connectors, such as dual jacks that receive dual plugs, can be used. The exposed end of the wall mounted connector 136 receives a second pair of transducer wires 140 which are used to electrically connect to an audio output in the amplifier deck 112 from which the voice or music signals originate.

As an alternative to the use of dedicated transducer wires 132 and 140, the transducer 120 may receive its voice or music signals via a wireless interface (not shown). In such an embodiment, a radio frequency (i.e., RF) or infrared frequency receiver circuit would be provided in the gang box 204, perhaps integral to the transducer body. The receiver, as well as perhaps and the transducer's sound generating coil, could be powered by a battery which may also be located in the gang box 204. This battery could be rechargeable via electrical alternating current (AC) power that is carried by conventional AC power wires that may be routed through the wall 124 and into the gang box 204. As another alternative, the voice or music signals can be carried by the conventional AC power wires, although such wires may allow a more limited range of audio frequency spectrum to be transmitted than can dedicated transducer wires.

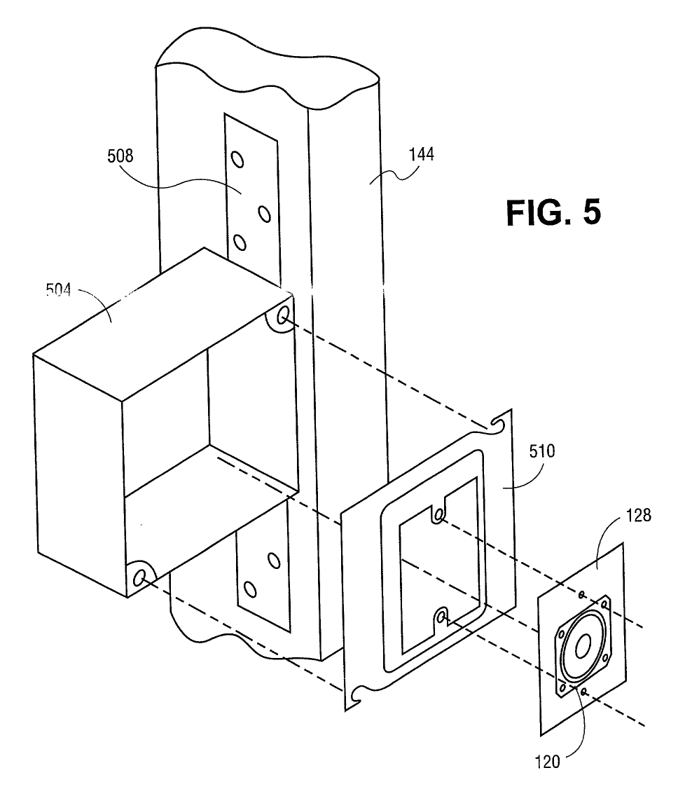

FIG. 2 shows a close-up side view of the transducer 120 mounted inside a wall mounted gang box 204, where, in this embodiment, the box 204 is attached to a section of dry wall 208 at two flanges 206 (at the top and bottom of the box 204 as shown). However, it is expected that the gang box 204 will most likely be attached through one of its sidewalls, using conventional techniques, to the vertical stud 144 in the wall (see FIG. 1) such as shown in FIG. 5 to be described below. Continuing to refer to FIG. 2, a conventionally made cut out in a section of dry wall 208 allows easy access into the gang box 204 to reach the transducer wires 132 whose ends electrically contact a connector (not shown) located in the rear portion of the transducer 120. As an alternative to dry wall, the gang box 204 may be mounted in other types residential or commercial wall units, including, for instance, lathe, plaster and perhaps concrete.

The transducer 120 is secured to the plate 128 using, in this embodiment, a flange 212 formed at the very front portion of the transducer body with front-to-back holes therein. Front facing screws 216 are passed through these holes and threaded into a number of hollows which can be seen in the front side of the plate 128 and are positioned outwardly of the enlarged opening. Other techniques for securing the transducer may be used, including the use of rear facing hollows in the back side of the plate 128 such that the back side of the plate 128 receives the flange 212 and the screws 216. Another technique is to provide a snap fit or clip mechanism on the back side of the plate 128 which mates with a cooperating mechanism on the flange 212. These techniques should be designed so that the front portion of the transducer body is located within the enlarged front-to-back opening of the plate 128 and is generally flush with the front side of the plate 128. In addition, most of the transducer body, including its rear portion which contains a coil (not shown) that moves the diaphragm, extends behind the plate 128 into the gang box 204.

The plate 128 may be attached to the gang box 204 at a number of points 220 on the plate, where such points are located outwards from the enlarged opening. These points may feature, for instance, front-to-back through holes which align with cooperating, standard holes in the outer periphery of the wall mounted gang box 204. It should be noted that the plate 128 can be attached to the gang box 204, and the transducer 120 can be secured to the plate, in any order. In some cases, such as when using a rear side attachment mechanism on the plate as described above, the transducer 120 may be secured to the plate 128, and the transducer wires connected to the connector on the transducer body, before attaching the plate 128 to the gang box. In other cases, the plate 128 may be attached to the gang box before connecting the transducer wires to the transducer 120 and then securing the transducer to the plate 128.

For aesthetic purposes, or to protect the exposed diaphragm 202, a grid or screen (not shown) may be snap-fitted into the recessed area 230 in the front of the plate 128.

In the embodiment of FIG. 2, some acoustic damping material 224 has been placed inside the gang box 204, behind the transducer 120, prior to mounting the transducer 120 inside the gang box 204. An example of such a material is DACRON brand fiber fill or standard fiberglass insulation material.

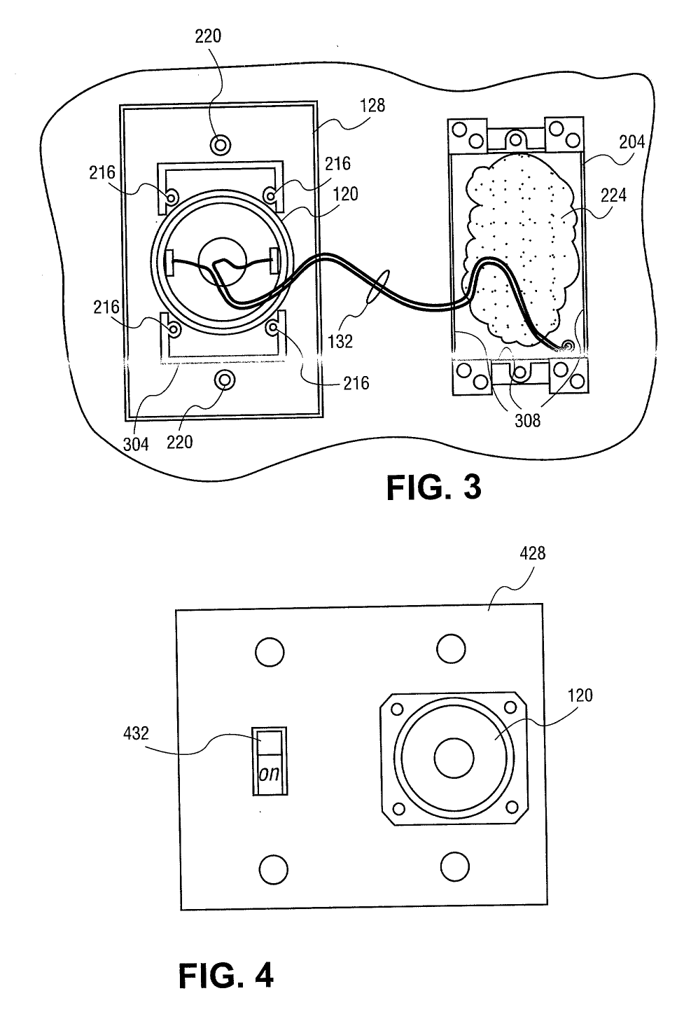

Referring now to FIG. 3, what is shown here is a rear view of the plate 128 to which the transducer 120 is secured, positioned next to the gang box 204 in which some acoustic damping material 224 has been placed. The plate mounting points 220 can be seen, lying outwardly of the enlarged opening through which the front portion the transducer 120 is received. In addition, a number of screws 216 for securing the transducer 120 to the front side of the plate 128, also lying outwardly of the enlarged opening, can also be seen. The transducer wires 132 can be seen as they are connected to the rear portion of the transducer 120.

FIG. 3 also shows an embodiment in which the plate 128 further includes a centering lip 304 that extends backwards from the back side of the plate 128. The lip 304 is positioned outwards of and substantially surrounds the enlarged opening, and cooperates with inner contour portions of the sidewalls 308 of the gang box, so as to center the plate 128 on the gang box 204. Thus, the lip 304 helps keep the transducer body from contacting any sidewalls 308 of the gang box 204. This feature may be desirable in situations where the gang box 204 is made of metal and the transducer body is not self shielded. In that case, without the centering lip, it may be difficult to hold the transducer in a fixed position inside a metal gang box because of strong forces being generated by the strong magnets in the transducer body.

Turning now to FIG. 4, an alternative embodiment of the wall-mounted transducer is shown in which a dual-gang box (not shown) is used. A larger plate 428 is shown that has been attached to and covers the dual-gang box. Secured to the dual-gang box is a toggle switch 432, using conventional means. Also, the transducer 120 is secured to the plate 428, such as according to any of the techniques described above for the single-gang embodiments shown in FIGS. 1-3. An alternative to the toggle switch 432 may be an AC receptacle or a light dimmer, both of which may be attached to the dual-gang box according to conventional techniques. As another alternative, a sound volume control mechanism (including a rheostat) can be attached to an empty location in a multi-gang (i.e., dual or greater) gang box. Such a mechanism would be coupled to receive transducer wiring through the box and control the volume of sound which is produced by the adjacent transducer and carried by the wiring.

Referring now to FIG. 5, another embodiment of the wall-mounted transducer is shown, this time using a larger, 4 inch by 4 inch square gang box 504. This larger gang box 504 is attached to the vertical stud 144 by securing a bracket 508 to the stud 144, again by conventional means. The box 504 has cut-outs (not shown) through which transducer wires are routed, in a manner similar to the single-gang embodiment of FIGS. 1-3. The combination of the transducer 120 and the single-gang plate 128 may be installed on the larger box 504, by way of a reducer 510. The plate 128 can be attached to the reducer 510 either prior to or after the reducer 510 itself is attached to the box 504.

The various embodiments of the method for installing a hi-fi sound system described above can essentially apply unchanged to install a voice paging (including an emergency instruction) system or a background music system, by simply connecting the transducer to the appropriate amplifier unit is such systems (rather than the deck component of the hi-fi sound system) and, if desired, using lower cost, and lower current capability wires that are suitable for lower sound volume systems. Yet another possible use is within a 70 Volt/100 Volt voice or music distributed sound system, such as those used in large office buildings and restaurants, that have 70 Volt/100 Volt distribution wiring as the transducer wires. In such an application, a transformer may be located in each gang box, in addition to the transducer, as an impedance transformer between the transducer and the 70/100 Volt distribution wiring. In addition, the methods for installing the wall mounted transducer can be applied to either indoor or outdoor commercial applications, such as parking lots and schools, where voice paging systems are used.

To summarize, various embodiments of a wall-mounted transducer suitable for hi-fi sound, voice paging, and music systems have been described. In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for installing a high fidelity sound system, a voice paging system, or a background music system, comprising:
securing an electrical to acoustic transducer to a plate having a front side and a back side, the transducer being suitable for use in one of said systems, the transducer having a front portion and rear portion and being sized to entirely fit inside an electrical gang box, a front-to-back enlarged opening in the plate sized to receive the front portion of the transducer, the transducer being secured to the plate so that the front portion is located within the front-to-back opening of the plate and is generally flush with the front side of the plate and most of the transducer including the rear portion extends behind the plate; and
attaching the plate at a plurality of points on the plate, where such points are located outwards from the opening, to a plurality of cooperating points in a wall-mounted electrical gang box.

2. The method of claim 1 wherein the transducer has an audible frequency response that is in the entire range of approximately 100 Hz-20 KHz for accurate voice or music reproduction.

3. The method of claim 1 further comprising:
connecting one end of a first pair of transducer wires, the wires being designed for conducting one of voice and music in said systems, to an electrical connector in the transducer.

4. The method of claim 3 further comprising:
routing the pair of transducer wires through a wall in which the electrical gang box is mounted, between a wire opening in the gang box and a wall-mounted electrical connector; and
connecting another end of the pair of transducer wires to the wall-mounted electrical connector.

5. The method of claim 4 further comprising:
connecting one end of a second pair of transducer wires to the wall-mounted electrical connector and connecting another end of the second pair to an audio output of an amplifier unit.

6. The method of claim 1 further comprising:
wherein the transducer is secured to the plate by a plurality of screws that are threaded into a plurality of hollows formed in the front side of the plate and positioned outwardly of the enlarged opening.

7. The method of claim 1 wherein the plate further includes a lip extending backwards from the back side of the plate and positioned outwards of and substantially surrounding the enlarged opening to center the plate on the gang box so that the transducer while being mounted in the gang box does not contact any sidewalls of the gang box.

8. The method of claim 1 further comprising:
placing some acoustic damping material inside and to the rear of the gang box prior to mounting the transducer therein.

9. The method of claim 1 wherein the gang box is a multi-gang box, the method further comprising:
attaching one of a toggle switch, a light dimmer, and a volume control mechanism to the box, prior to attaching the plate to the box, wherein said volume control mechanism is further coupled to receive transducer wiring through the box and control the volume of sound produced by the transducer and carried by the wiring.

10. The method of claim 5 wherein the amplifier unit is part of a background music system from which the music is controlled.

11. The method of claim 5 wherein the amplifier unit is part of a voice paging system from which the voice is controlled.

12. The method of claim 1 wherein the transducer includes a casing having an inner surface and an outer surface, a pole piece within the casing, having an outer surface, and an inner surface defining a venting passage therethrough, a substantially annular gap being defined between the inner surface of the casing and the outer surface of the pole piece, a substantially circular magnetic structure in the annular gap, being radially polarized so as to have a first polarity on an inner surface and a second polarity on an outer surface so as to create a line of magnetic flux following a loop sequentially from the outer surface of the magnetic structure to the casing, from the casing to the pole piece, and from the pole piece to the inner surface of the magnetic structure, the casing, the pole piece and the magnetic structure being mounted to one another to form a magnet assembly which defines an annular coil gap with the path of the loop being across the coil gap, a diaphragm, a suspension mechanism having a first portion attached to the magnet assembly and a second portion attached to the diaphragm so as to mount the diaphragm to the suspension mechanism, the suspension mechanism allowing for travel of the diaphragm relative to the magnet assembly, the diaphragm and the suspension mechanism jointly defining at least part of an enclosure, and an electric coil located in the coil gap and having a portion connected to the diaphragm so that an electric current in the coil causes movement of the diaphragm, movement of the diaphragm causing movement of air through the venting passage between the enclosure and externally of the magnet assembly, the travel of the diaphragm being at least 0.1 times a diameter of the diaphragm.
